(19) United States
(12) Patent Application Publication
(10) Pub. No.: US 2024/0329933 A1
(43) Pub. Date: Oct. 3, 2024

(54) NEURAL ENGINE WITH ACCELERATED MULTIPILER-ACCUMULATOR FOR CONVOLUTION OF INTERGERS

(71) Applicant: Apple Inc., Cupertino, CA (US)

(72) Inventors: Lei Wang, San Carlos, CA (US); Jaewon Shin, Los Altos, CA (US); Seungjin Lee, Los Altos, CA (US); Ji Liang Song, Cupertino, CA (US); Michael L. Liu, Los Altos, CA (US); Christopher L. Mills, Saratoga, CA (US)

(21) Appl. No.: 18/127,650

(22) Filed: Mar. 28, 2023

(51) Int. Cl. G06F 7/544; G06N 3/063

(52) U.S. Cl. CPC G06F 7/5443; G06N 3/063

(57) ABSTRACT

Embodiments of the present disclosure relate to a multiply-accumulator circuit that includes a main multiplier circuit operable in a floating-point mode or an integer mode and a supplemental multiplier circuit that operates in the integer mode. The main multiplier circuit generates a multiplied output that undergoes subsequent operations including a shifting operation in the floating-point mode whereas the supplemental multiplier generates another multiplied output that does not undergo any shifting operations. Hence, in the integer mode, two parallel multiply-add operations may be performed by the two multiplier circuits, and therefore accelerate the multiply-adder operations. Due to the lack of additional shifters associated with the supplemental multiplier circuit, the multiply-accumulator circuit does not have a significantly increased footprint.

### BACKGROUND

### 1. Field of the Disclosure

The present disclosure relates to a circuit for accelerating convolution operations in a neural processor, and more specifically to adding multipliers in multiply-accumulators to accelerate convolution operations.

### 2. Description of the Related Arts

An artificial neural network (ANN) is a computing system or model that uses a collection of connected nodes to process input data. The ANN is typically organized into layers where different layers perform different types of transformation on their input. Extensions or variants of ANN such as convolution neural network (CNN), recurrent neural networks (RNN) and deep belief networks (DBN) have come to receive much attention. These computing systems or models often involve extensive computing operations including multiplication and accumulation. For example, CNN is a class of machine learning technique that primarily uses convolution between input data and kernel data, which can be decomposed into multiplication and accumulation operations.

Depending on the types of input data and operations to be performed, these machine learning systems or models can be configured differently. Such varying configuration would include, for example, pre-processing operations, the number of channels in input data, kernel data to be used, non-linear function to be applied to convolution result, and applying of various post-processing operations. Using a central processing unit (CPU) and its main memory to instantiate and execute machine learning systems or models of various configuration is relatively easy because such systems or models can be instantiated with mere updates to code. However, relying solely on the CPU for various operations of these machine learning systems or models would consume significant bandwidth of the CPU as well as increase the overall power consumption.

### SUMMARY

Embodiments relate to a multiply-accumulator circuit in a neural processor circuit that includes multiplier circuits that perform multiplication operations in parallel during an integer mode. The multiply-accumulator circuit includes a first multiplier circuit that performs multiplication on at least part of a first input data with a first kernel coefficient in a floating-point mode and in an integer mode to generate a first multiplied output, and a second multiplier circuit that performs multiplication on a second input data with a second kernel coefficient in parallel with the first multiplier circuit in the integer mode to generate a second multiplied output. A first accumulator stores a first accumulator value determined by at least adding the first multiplied output. A second accumulator stores second accumulator value determined by at least adding the second multiplied output.

### BRIEF DESCRIPTION OF THE DRAWINGS

Figure (FIG. 1 is a high-level diagram of an electronic device, according to one embodiment.

FIG. 2 is a block diagram illustrating components in the electronic device, according to one embodiment.

FIG. 3 is a block diagram illustrating a neural processor circuit, according to one embodiment.

FIG. 4 is a block diagram of a neural engine in the neural processor circuit, according to one embodiment.

FIG. 5 is a block diagram of a multiply-accumulator in the neural engine with two multipliers, according to one embodiment.

FIG. 6 is a block diagram of a multiply-accumulator in the neural engine with more than two multipliers, according to one embodiment.

FIG. 7 is a flowchart illustrating a method of operating a multiply-accumulator, according to one embodiment.

The figures depict, and the detail description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to a multiply-accumulator circuit that includes a main multiplier circuit operable in a floating-point mode or an integer mode and a supplemental multiplier circuit that operates in the integer mode. The main multiplier circuit generates a multiplied output that undergoes subsequent operations including a shifting operation in the floating-point mode whereas the supplemental multiplier generates another multiplied output that does not undergo any shifting operations. Hence, in the integer mode, two parallel multiply-add operations may be performed by the two multiplier circuits, and therefore accelerate the multiply-adder operations. Due to the lack of additional shifters associated with the supplemental multiplier circuit, the multiply-accumulator circuit does not have a significantly increased footprint.

The floating-point mode described herein refers to a mode where operands of a multiplier operation are both expressed in terms of floating-point numbers.

The integer mode described herein refers to a mode where operands of a multiplier operation are both expressed in terms of integer numbers.

### Exemplary Electronic Device

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with Figure (FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1 such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application-specific integrated circuits (ASICs).

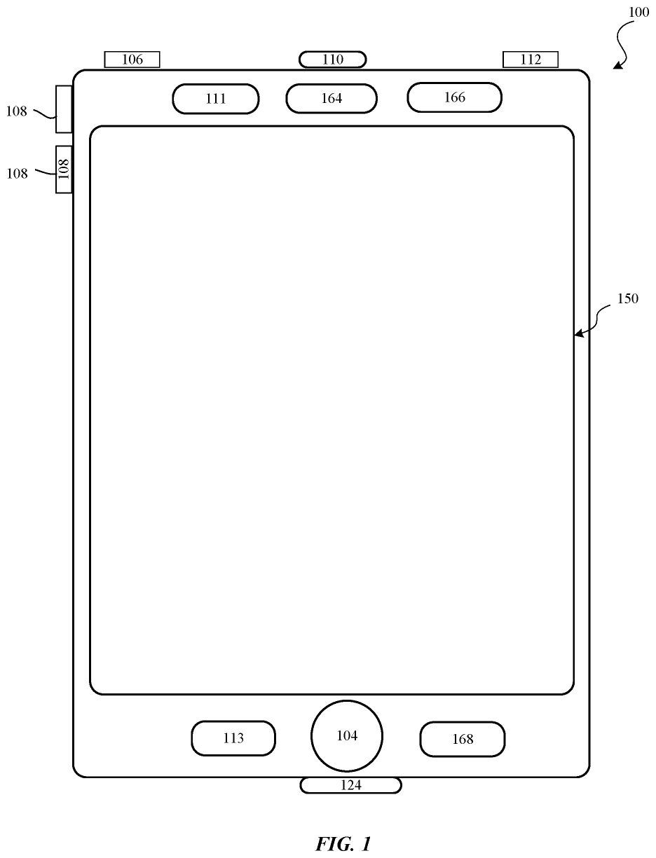

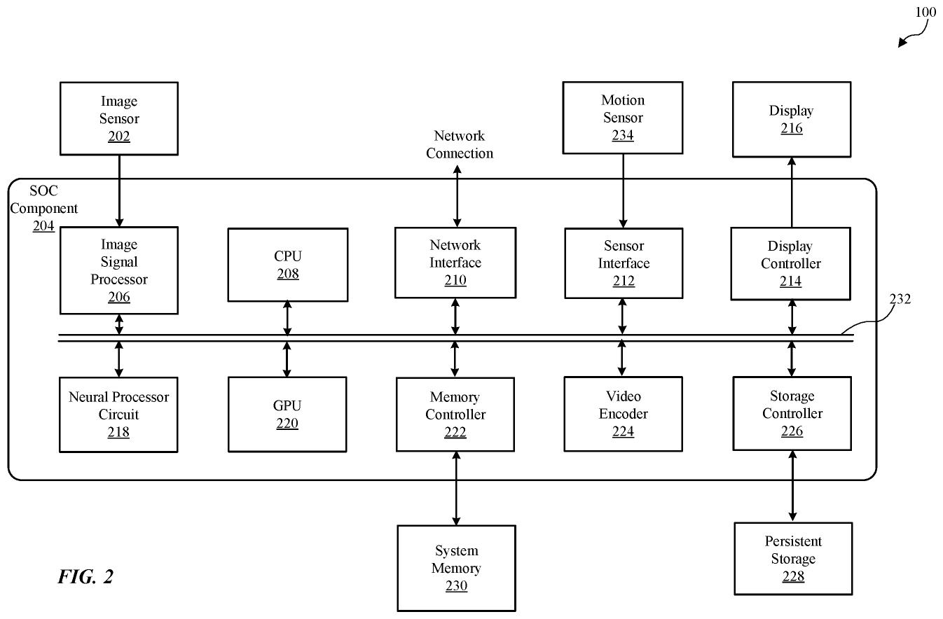

FIG. 2 is a block diagram illustrating components in device 100, according to one embodiment. Device 100 may perform various operations including implementing one or more machine learning models. For this and other purposes, device 100 may include, among other components, image sensors 202, a system-on-a chip (SOC) component 204, a system memory 230, a persistent storage (e.g., flash memory) 228, a motion sensor 234, and a display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results in runtime using the models. For example, in one case, device 100 captures facial images of the user and uses the images to continue to improve a machine learning model that is used to lock or unlock the device 100.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

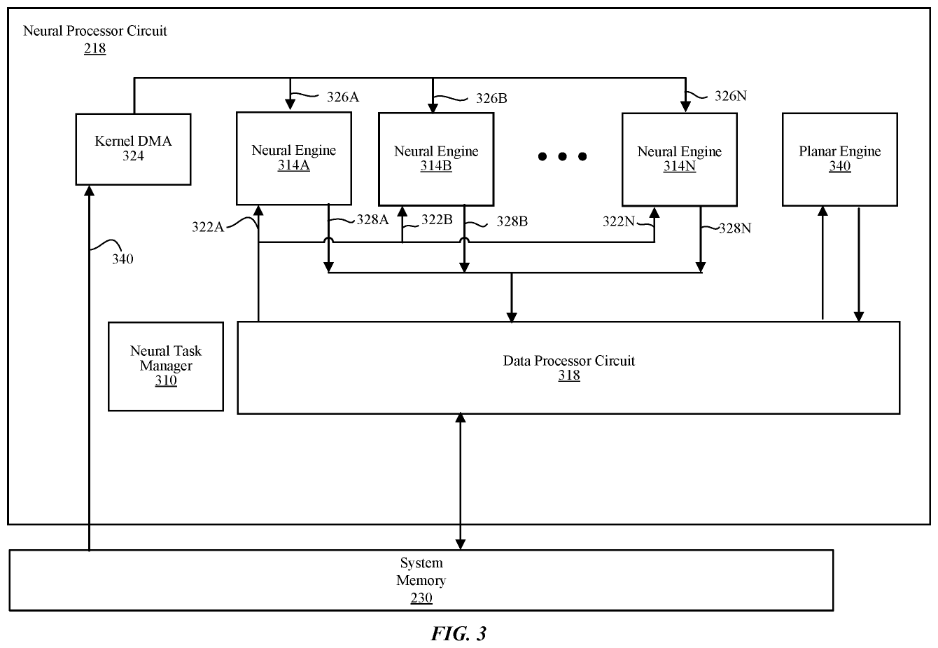

Neural processor circuit 218 is a circuit that performs various machine learning operations based on computation including multiplication, addition, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, ISP 206, persistent storage 228, system memory 230 or other sources such as network interface 210 or GPU 220. The output of neural processor circuit 218 may be provided to various components of device 100 such as ISP 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to ISP 206) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor circuit 218, ISP 206, CPU 208 or GPU 220. Such software components may be stored in system memory 230, persistent storage 228 or another device communicating with device 100 via network interface 210.

### Example Neural Processor Circuit

Neural processor circuit 218 is a programmable circuit that performs machine learning operations on the input data of neural processor circuit 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as hidden layers. Each layer may include one or more nodes, which may be fully or partially connected to other nodes in adjacent layers. In forward propagation, the neural network performs computation in the forward direction based on outputs of a preceding layer. The operation of a node may be defined by one or more functions. The functions that define the operation of a node may include various computation operation such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tanh), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent such as stochastic coordinate descent (SGD) to adjust the coefficients in various functions to improve the value of the loss function.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, gradient data) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network is discussed as an example, neural processor circuit 218 may also be used for the operations of other types of machine learning models, such as a kernel SVM.

Referring to FIG. 3, an example neural processor circuit 218 may include, among other components, a neural task manager 310, neural engines 314A through 314N (hereinafter collectively referred as “neural engines 314” and individually also referred to as “neural engine 314”), a kernel direct memory access (DMA) 324, a data processor circuit 318, and a planar engine 340. Neural processor circuit 218 may include fewer or additional components not illustrated in FIG. 3.

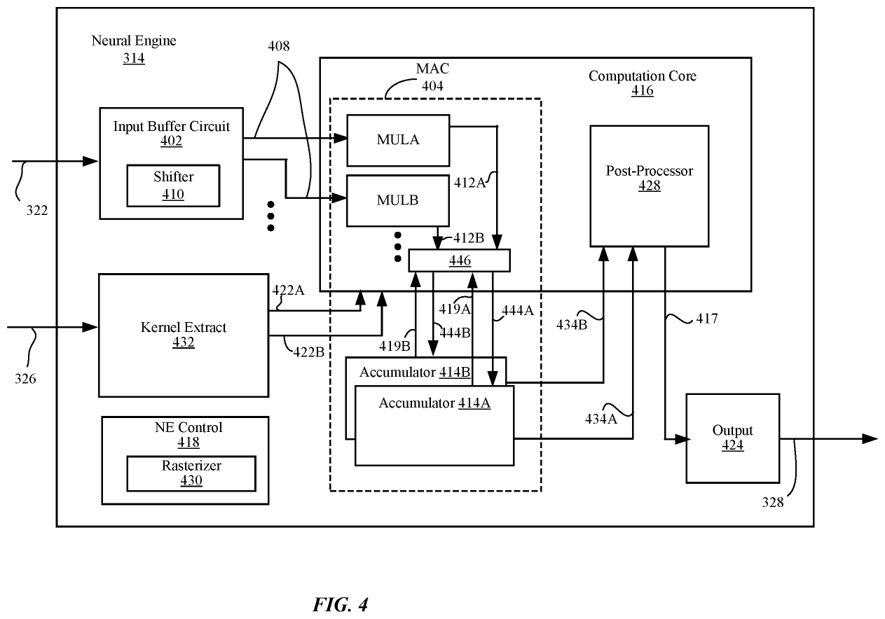

Each of neural engines 314 performs computing operations for machine learning in parallel. Depending on the load of operation, the entire set of neural engines 314 may be operating or only a subset of the neural engines 314 may be operating while the remaining neural engines 314 are placed in a power-saving mode to conserve power. Each of neural engines 314 includes components for storing one or more kernels, for performing multiply-accumulate operations, and for post-processing to generate an output data 328, as described below in detail with reference to FIG. 4. Neural engines 314 may specialize in performing computation heavy operations such as convolution operations and tensor product operations. Convolution operations may include different kinds of convolutions, such as cross-channel convolutions (a convolution that accumulates values from different channels), channel-wise convolutions, and transposed convolutions.

Planar engine 340 may specialize in performing simpler computing operations whose speed may primarily depend on the input and output (I/O) speed of the data transmission instead of the computation speed within planar engine 340. Those computing operations may be referred to as I/O bound computations. In contrast, neural engines 314 may focus on complex computation whose speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In one embodiment, input data may be a tensor whose rank is larger than three (e.g., having three or more dimensions). A set of dimensions (two or more) in the tensor may be referred to as a plane while another dimension may be referred to as a channel. Neural engines 314 may convolve data of a plane in the tensor with a kernel and accumulate results of the convolution of different planes across different channels. On the other hand, planar engine 340 may specialize in operations within the plane.

Neural task manager 310 manages the overall operation of neural processor circuit 218. Neural task manager 310 may receive a task list from a compiler executed by CPU 208, store tasks in its task queues, choose a task to perform, and send task commands to other components of neural processor circuit 218 for performing the chosen task. Data may be associated with a task command that indicates the types of operations to be performed on the data. Data of neural processor circuit 218 includes input data that is transmitted from another source such as system memory 230, and data generated by neural processor circuit 218 in a previous operating cycle. Each dataset may be associated with a task command that specifies the type of operations to be performed on the data. Neural task manager 310 may also perform switching of tasks on detection of events such as receiving instructions from CPU 208. In one or more embodiments, neural task manager 310 sends rasterizer information to the components of neural processor circuit 218 to enable each of the components to track, retrieve or process appropriate segments of the input data and kernel data. For example, neural task manager 310 may include registers that stores the information regarding the size and rank of a dataset for processing by neural processor circuit 218. Although neural task manager 310 is illustrated in FIG. 3 as part of neural processor circuit 218, neural task manager 310 may be a component outside neural processor circuit 218.

Kernel DMA 324 is a read circuit that fetches kernel data from a source (e.g., system memory 230) and sends kernel data 326A through 326N to each of neural engines 314. Kernel data represents information from which kernel elements can be extracted. In one embodiment, the kernel data may be in a compressed format which is decompressed at each of neural engines 314. Although kernel data provided to each of neural engines 314 may be the same in some instances, the kernel data provided to each of neural engines 314 is different in most instances. In one embodiment, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include temporary storage for storing data associated with operations of neural processor circuit 218 and planar engine 340, such as input data that is transmitted from system memory 230 (e.g., data from a machine learning model) and other data that is generated within neural processor circuit 218 or planar engine 340. The data stored in data processor circuit 318 may include different subsets that are sent to various downstream components, such as neural engines 314 and planar engine 340. Data processor circuit 318 also controls the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230.

The data processed by neural processor circuit 218 may be part of, among others, image data, histogram of oriented gradients (HOG) data, audio data, metadata, output data 328 of a previous operating cycle of neural engine 314, and other processed data received from other components of SOC component 204.

### Example Neural Engine Architecture

FIG. 4 is a block diagram of neural engine 314, according to one embodiment. Neural engine 314 performs various operations to facilitate machine learning such as convolution, tensor product, and other operations may involve heavy computation. For this purpose, neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or span across multiple channels.

Neural engine 314 may include, among other components, input buffer circuit 402, computation core 416, neural engine (NE) control 418, kernel extract circuit 432, accumulator circuits 414A, 414B and output circuit 424. Neural engine 314 may include fewer components than what is illustrated in FIG. 4 or include further components not illustrated in FIG. 4.

Input buffer circuit 402 is a circuit that stores a subset of the data of neural processor circuit 218 as the subset of data is received from a source. The source may be data processor circuit 318, planar engine 340, or another suitable component. Input buffer circuit 402 sends an appropriate segment 408 of input data for a current task or process loop to computation core 416 for processing. Input buffer circuit 402 may include a shifter 410 that shifts read locations of input buffer circuit 402 to change segment 408 of input data sent to computation core 416. By changing segments of input data provided to computation core 416 via shifting, neural engine 314 can perform multiply-accumulate for different segments of input data based on a fewer number of read operations. In one or more embodiments, the data of neural processor circuit 218 includes data of difference convolution groups and/or input channels.

Kernel extract circuit 432 is a circuit that receives kernel data 326 from kernel DMA 324 and extracts kernel coefficients 422. In one embodiment, kernel extract circuit 432 references a lookup table (LUT) and uses a mask to reconstruct a kernel from compressed kernel data 326 based on the LUT. The mask indicates locations in the reconstructed kernel to be padded with zero and remaining locations to be filled with numbers. Kernel coefficients 422 of the reconstructed kernel are sent to computation core 416 to populate register in multiply-accumulator (MAC) 404 of computation core 416. In other embodiments, kernel extract circuit 432 receives kernel data in an uncompressed format and the kernel coefficients are determined without referencing a LUT or using a mask.

Computation core 416 is a programmable circuit that performs computation operations. For this purpose, computation core 416 may include multiplier circuits MULA, MULB (herein collectively referred to as “multiplier circuits MUL”), an adder-shifter 446, and a post-processor 428. Computation core 416 may include components other than what is illustrated in FIG. 4.

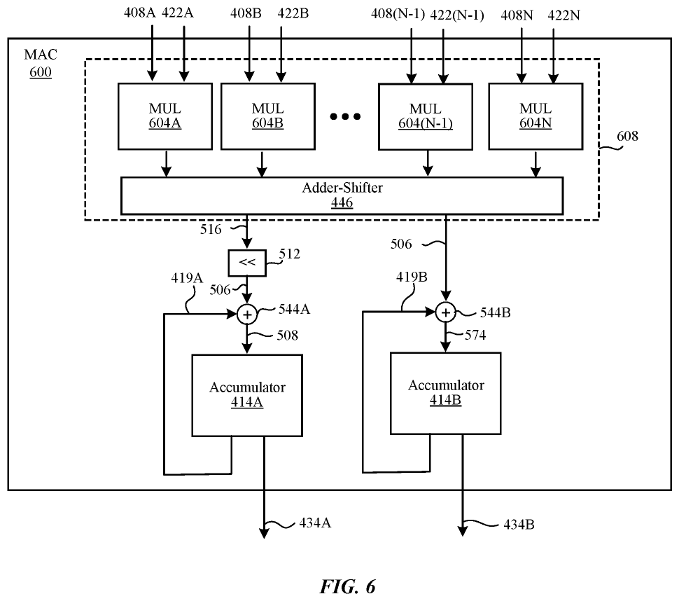

Each of multiplier circuits MUL performs a multiplier operation on a segment 408 of the input data using one or more of kernel coefficients 422. Multiplier circuits MULA, MULB may multiply a segment of input data in multiple bits with a kernel coefficient of multiple bits, and each multiplier circuit may have different capabilities and configuration. For example, multiplier circuit MULA is capable of performing multiplication in a float-point mode or in an integer mode while multiplier MULB is capable of performing multiplication only in the integer mode. Further, multiplier circuit MULA may be capable of multiplying operands with a bit length that is longer than those of multiplier circuit MULB. For example, multiplier circuit MULA may perform 11 bit×11 bit multiplication while multiplier circuit MULB may only perform up to 8 bit×8 bit multiplication. Although only two multiplier circuits MULA and MULB are illustrated in FIG. 4, more than two multiplier circuits may be provided as described below with reference to FIG. 6. As a result of multiplication multiplier circuits MULA, MULB generates multiplied outputs 412A, 412B, respectively.

Adder-shifter 446 is a combination of binary shifter circuits and adder circuits that may be connected in various manners. Multiplied outputs 412A, 412B are fed to adder-shifter 446 to generate added values 444A, 444B, respectively, for storing in accumulator circuits 414A, 414B. Depending on the mode of operations (e.g., floating-point mode or integer mode), the multiplied output may bypass shifter circuits in adder-shifter 446. For example, when in the integer mode, the multiplied outputs 412A, 412B may bypass shifter circuits in adder-shifter 446 while multiplied output 412A in the floating-point mode may undergo binary shifting by the shifter circuits in adder-shifter 446.

Accumulator circuits 414A, 414B are memory circuits that receive and store added values 444A, 444B from adder-shifter 446 The added values 444A, 444B are stored in accumulator circuit 414, and may be sent back as accumulator values 419A, 419B for further adding operations at adder-shifter 446 or sent to post-processor 428 as accumulator outputs 434A, 434B (hereinafter collectively referred to as “accumulator outputs 434”) for post-processing. Accumulator circuits 414A, 414B in combination with adder-shifter 446 and multiplier circuits form a multiply-accumulator (MAC) 404. In one or more embodiments, one or more of accumulator circuits 414A, 414B may have subunits (or batches) where each subunit sends data to different components of neural engine 314. For example, during an operating cycle, data stored in a first subunit of accumulator circuit 414A is sent to adder-shifter 446 while data stored in a second subunit of accumulator circuit 414A is sent to post-processor 428. Further, although accumulator circuits 414A, 414B are illustrated as separate hardware components in FIG. 4, both accumulators may share the same bank of memory circuits that may be assigned to different logical accumulators.

Post-processor 428 is a circuit that performs further processing of accumulator outputs 434A, 434B received from accumulator circuits 414A, 414B. Post-processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values 417 to output circuit 424. In some embodiments, the processing at post-processor 428 is bypassed. For example, the data in accumulator circuits 414A, 414B may be sent directly to output circuit 424 for access by other components of neural processor circuit 218.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from MAC 404, and perform different types of post-processing operations at post-processor 428. To configure components of neural engine 314 to operate in a desired manner, NE control 418 sends task commands to components of neural engine 314. NE control 418 may include a rasterizer 430 that tracks the current task or process loop being processed at neural engine 314.

Rasterizer 430 may perform the operations associated with dividing the input data into smaller units (e.g., segments) and regulate the processing of the smaller units through MAC 404 and accumulator circuit 414. Rasterizer 430 keeps track of sizes and ranks of segments of the input/output data (e.g., groups, work units, input channels, output channels) and instructs the components of a neural processor circuit 218 for proper handling of the segments of the input data. For example, rasterizer 430 operates shifters 410 in input buffer circuits 402 to forward correct segments 408 of input data to MAC 404 and send the finished output data 328 to data buffer memory 334. Other components of neural processor circuit 218 (e.g., planar engine 340) may also have their corresponding rasterizers to monitor the division of input data and the parallel computation of various segments of input data in different components.

Output circuit 424 receives processed values 417 from post-processor 428 and interfaces with data processor circuit 318 to store processed values 417 in data processor circuit 318. For this purpose, output circuit 424 may send out output data 328 in a sequence or a format that is different from the sequence or format in which the processed values 417 are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include, but are not limited to, mapping between input data elements and kernel elements, the number of input channels, the number of output channels, performing of output strides, and enabling/selection of post-processing operations at post-processor 428.

### Example Multiply-Accumulator

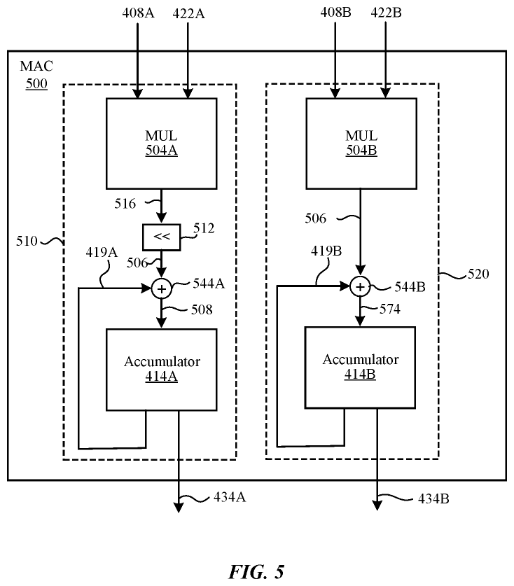

FIG. 5 is a block diagram of MAC 500 with two multipliers 504A, 504B, according to one embodiment. MAC 500 may be MAC 404 of FIG. 4 where only two multipliers MULA, MULB are provided. MAC 500 includes two pipelines 510, 520. Pipeline 510 is a main pipeline that may operate in both the floating-point mode and the integer mode whereas pipeline 520 is a supplemental pipeline that operates only in the integer mode. In the floating-point mode, pipeline 520 is inactivated and only pipeline 510 produces an output. In the integer mode, pipeline 510 and pipeline 520 are operated in parallel to double the speed of MAC operation.

Pipeline 510 receives segment 408A of input data and kernel coefficient 422A, performs MAC operation on the received data, and outputs accumulator outputs 434A. For this purpose, pipeline 510 may include, among other components, multiplier 504A, shifter circuit 512, and accumulator circuit 414A. In MAC 500, shifter circuit 512 and adders 544A, 544B correspond to adder-shifter 446 in FIG. 4. Segment 408A and kernel coefficient 422A may be floating-point numbers or integer numbers depending on the mode. In one or more embodiments, segment 408 and/or kernel coefficient 422A may be of a longer bit length in the floating-point mode than in the integer mode. Alternatively, certain bits of segment 408 and/or kernel coefficient 422A may be padded with zero in the integer mode.

In one or more embodiments, only part (e.g., certain bits) of input data are provided as segment 408A while the remaining part (e.g., remaining bits of the same input data) is provided as segment 408B. That is, multipliers 504A, 504B share the same path to input buffer circuit 402 but operate on different parts (e.g., bits) of the same input data. In other embodiments, segment 408A and segment 408B may at least partially overlap. Further, multipliers 504A, 504B may each be provided with different input data. In a similar manner, multipliers 504A, 504B may be provided with the different parts (e.g., bits) of the same kernel coefficient (e.g., the most significant bits to multiplier 504A and remaining bits to multiplier 504B). Alternatively, multipliers 504A, 504B may be provided with different kernel coefficients.

Multiplier 504A is a circuit that performs binary multiplication on part of or entire segment 408A of input data and kernel coefficient 422A. Multiplier 504A may be used in combination of shifter circuit 512 to perform a multiplication operation in the floating-point mode. Multiplier 504 may also generate a multiplied value by itself in the integer mode. Specifically, in the floating-point mode, output 516 from multiplier 504A is fed to shifter circuit 512 to produce multiplied value 506. In the integer mode, output 516 bypasses shifter circuit 512 (without being processed further) and is provided as multiplied value 506 to adder 544A.

In the first cycle, multiplied value 506 passes through adder 544A and is stored in accumulator circuit 414A. In subsequent cycles, multiplied value 506 is added with accumulator value 419A stored in accumulator circuit 414A by adder 544A to produce updated value 508 for storing in accumulator circuit 414A. Updated value 508 is then provided as accumulator value 419A in the next cycle to adder 544A to perform the accumulation operation. The stored value in accumulator circuit 414A at the conclusion of an accumulation operation is sent out as accumulator output 434A.

Pipeline 520 has limited functionality relative to pipeline 510. That is, pipeline 520 may only operate in the integer mode while being inactivated in the floating-point mode. Pipeline 520 may include, among other components, multiplier 504B, adder 444B and accumulator circuit 414B. Pipeline 520 also does not include a shifter that may take up a large footprint in MAC 500, and hence, pipeline 520 is smaller compared to pipeline 510. Moreover, adder 444B may be smaller than adder 444A, further reducing the size of pipeline 520 relative to pipeline 510. Pipeline 520 may work in parallel with pipeline 510 to accelerate MAC operation in the integer mode.

The operation and the structure of multiplier 504B may be similar or the same as those of multiplier 504A. That is, multiplier 504B receives a part of or entire segment 408B of input data and kernel coefficient 422b, performs multiplication operation, and produces multiplied value 506. Multiplied value 506 is added with accumulator value 419B into updated value 574 by adder 544B. Added value 574 is stored in accumulator circuit 414B to repeat the process of accumulation in the next cycle. The stored updated value at the end of the accumulation operation is output as accumulator output 434B by accumulator circuit 414B.

Various modification may be made to MAC 500. Although only two pipelines 510, 520 are illustrated in FIG. 5, additional supplemental pipelines may be provided to further accelerate MAC 500 in the integer mode. Further, additional components such as memory circuits may be provided in pipelines 510, 520.

FIG. 6 is a block diagram of MAC 600 with more than two multipliers 604A through 604N, according to one embodiment. MAC 600 is similar to MAC 500 in that adders 544A, 544B and accumulator circuits 414A, 414B are provided. The operations of these components in MAC 600 are the same as those of MAC 500, and hence, the detailed description thereof is omitted herein for the sake of brevity. However, MAC 600 is different from MAC 500 in that MAC 600 has multiplication block 608 that operates differently in the integer mode and the floating-point mode.

Multiplication block 608 performs a multiplication operation to produce output 516 in the floating-point mode, and produce both output 516 and multiplied value 506 in the integer mode. Multiplication block 608 includes a plurality of multipliers 604A through 604N (hereinafter collectively referred to as “multipliers 604”), and an adder-shifter 466. In different modes, different combinations of multipliers 604 may be activated. For example, all of multipliers 604 may be active in the integer mode whereas only a subset of multipliers 604 may be active during the floating-point mode. Segment 408 and/or kernel coefficient 422 of different bit lengths may be used in different operating modes (e.g., operands of 11-bit length used in the floating-point mode, and operands of 8-bit length used in the integer mode). By dividing two multipliers (as shown, for example, in FIG. 5) into smaller multipliers and operating them separately in different modes (as shown, for example, in FIG. 6), the leftover bits in segment 408 and/or kernel coefficient 422 that would otherwise have been padded with zero values may be effectively used in the multiplication operations by MAC 600.

Adder-shifter 446 is a circuit that includes a combination of adders and shifters. The adders and the shifters may be connected in various manners so that adder-shifter 446 produces multiplied value 506 and output 516 in a desired manner. The sequence of adding and shifting operations on the results from different multipliers 604 may differ. For example, multiplier 604B may perform multiplication on three most significant bits of segment 408 (shown as 408B) and three most significant bits of kernel 422 (shown as 422B) to generate a result that is shifted by a certain number of bits by a shifter in adder-shifter 446 before being added with a result from a multiplication operation performed by multiplier 604A on remaining bits of segment 408 (shown as 408A) and kernel 422 (shown as 422A).

Various modification may be made to MAC 600. Although only two accumulator circuits 414A, 414B and two adders 544A, 544B are shown in FIG. 6, more sets of adders and accumulators may be added in different embodiments. Further additional memory circuits may be added in MAC 600. Further, only one accumulator output (e.g., 434A) may be provided to post-processor 428 in certain modes.

### Example Processes at Neural Engine Architecture

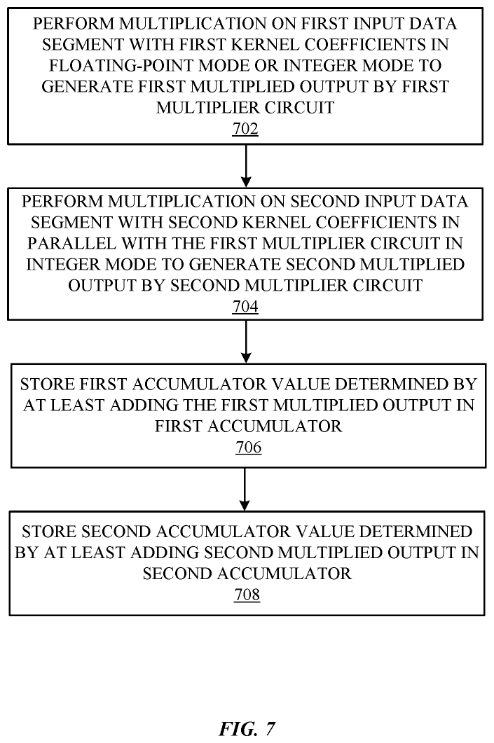

FIG. 7 is a flowchart illustrating a method of operating a multiply-accumulator, according to one embodiment. Multiplication is performed 702 on at least part of a first input data segment with a first kernel coefficient in a floating-point mode or an integer mode to generate a first multiplied output by a first multiplier circuit (e.g., MUL 504A or MUL 605A) of the multiply-accumulator circuit. The output from the multiplier may be shifted to obtain the first multiplied output in the floating-point mode whereas the output from the multiplier may correspond to the first multiplied output without further shifting in the integer mode.

Multiplication may be performed 704 on a second input data segment with a second kernel coefficient in parallel with the first multiplier circuit in the integer mode to generate a second multiplied output by a second multiplier circuit (e.g., MUL 504B or MUL 604B) of the multiply-accumulator circuit.

A first accumulator value determined by at least adding the first multiplied output is stored 706 in a first accumulator circuit (e.g., 414A). In one or more embodiments, the first multiplied output may be continuously accumulated to generate a first accumulator output.

A second accumulator value determined by at least adding the second multiplied output is stored 708 in a second accumulator circuit (e.g., 414B). In one or more embodiments, the second multiplied output may be continuously accumulated to generate a second accumulator output.

Embodiments of the process as described above with reference to FIG. 7 are merely illustrative. Moreover, sequence of the process may be modified or omitted. Further, some of the processes may be performed in parallel. For example, the process of multiplying 702 and 704 may be performed in parallel.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A multiply-accumulator circuit in a neural processor circuit, comprising:
a plurality of multiplier circuits comprising:
a first multiplier circuit configured to perform multiplication on a first input data with at least part of a first kernel coefficient in a floating-point mode or an integer mode to generate a first multiplied output, and
a second multiplier circuit configured to perform multiplication on a second input data with a second kernel coefficient in parallel with the first multiplier circuit in the integer mode to generate a second multiplied output;
a first accumulator configured to store a first accumulator value determined by at least adding the first multiplied output; and
a second accumulator configured to a second accumulator value determined by at least adding the second multiplied output.

2. The multiply-accumulator circuit of claim 1, wherein the first input data is of a first bit size, the first kernel coefficient is of a second bit size, the second input data is of a third bit size and the second kernel coefficient is of a fourth bit size.

3. The multiply-accumulator circuit of claim 1, wherein the second multiplier circuit is inactive in the floating-point mode.

4. The multiply-accumulator circuit of claim 3, wherein the first multiplied output and the second multiplied output are generated in a same cycle of the neural processor circuit.

5. The multiply-accumulator circuit of claim 1, further comprising an adder-shifter circuit coupled to the first multiplier circuit to receive the first multiplied output, the adder-shifter circuit coupled to the second multiplier circuit to receive the second multiplied output, the adder-shifter circuit configured to perform a shift operation on a first added value derived from the first multiplied output.

6. The multiply-accumulator circuit of claim 5, wherein the adder-shifter circuit does not perform a shift operation on a second added value derived from the second multiplied output.

7. The multiply-accumulator circuit of claim 5, further comprising a third multiplier circuit configured to generate a third multiplied output and a fourth multiplier circuit configured to generate a fourth multiplied output, the first added value derived by at least adding the first multiplied output and the third multiplied output, and the second added value derived by at least adding the second multiplied output with the fourth multiplied output.

8. The multiply-accumulator circuit of claim 1, wherein the first input data includes the most significant bits of an input data and the second input data includes bits of the input data other than the most significant bits.

9. The multiply-accumulator circuit of claim 2, wherein the third bit size and the fourth bit size are different.

10. The multiply-accumulator circuit of claim 2, wherein the first bit size is larger than the third bit size.

11. A method of operating a multiply-accumulator circuit in a neural processor circuit, comprising:
performing multiplication on at least part of a first input data with a first kernel coefficient in a floating-point mode or an integer mode to generate a first multiplied output by a first multiplier circuit of the multiply-accumulator circuit;
performing multiplication on a second input data with a second kernel coefficient in parallel with the first multiplier circuit in the integer mode to generate a second multiplied output by a second multiplier circuit of the multiply-accumulator circuit;
storing a first accumulator value determined by at least adding the first multiplied output in a first accumulator; and
storing a second accumulator value determined by at least adding the second multiplied output in a second accumulator.

12. The method of claim 11, wherein the first input data is of a first bit size, the first kernel coefficients is of a second bit size, the second input data is of a third bit size and the second kernel coefficients is of a fourth bit size.

13. The method of claim 11, further comprising inactivating the second multiplier circuit in the floating-point mode.

14. The method of claim 11, wherein the first multiplied output and the second multiplied output are generated in a same cycle of the neural processor circuit.

15. The method of claim 11, further comprising performing a shift operation on a first added value derived from the first multiplied output by an adder-shifter circuit.

16. The method of claim 15, further comprising generating a third multiplied output by a third multiplier circuit, the first added value derived by at least adding the first multiplied output and the third multiplied output;

17. The method of claim 11, wherein the first input data includes the most significant bits of an input data and the second input data includes bits of the input data other than the most significant bits.

18. The method of claim 12, wherein the third bit size and the fourth bit size are different.

19. The method of claim 12, wherein the first bit size is larger than the third bit size.

20. An electronic device, comprising:
a system memory storing input data including a first input data and a second input data; and
a neural processor circuit coupled to the system memory, the neural processor circuit including:
a first multiplier circuit configured to perform multiplication on at least part of a of the first input data with a first kernel coefficient in a floating-point mode of in an integer mode to generate a first multiplied output,
a second multiplier circuit configured to perform multiplication on a of the second input data with a second kernel coefficient in parallel with the first multiplier circuit in the integer mode to generate a second multiplied output,
a first accumulator configured to store a first accumulator value determined by at least adding the first multiplied output, and
a second accumulator configured to a second accumulator value determined by at least adding the second multiplied output.
